(19) United States
(12) Patent Application Publication
(10) Pub. No.: US 2014/0058787 A1
(43) Pub. Date: Feb. 27, 2014

(54) Plan Choosing in Digital Commercial Print Workflows

(71) Applicant: Ron Banner, Yokneam (IL)

(72) Inventor: Ron Banner, Yokneam (IL)

(21) Appl. No.: 13/989,786

(22) PCT Filed: May 5, 2011
(86) PCT No.: PCT/US11/35377

§ 371 Date: May 25, 2013

(51) Int. Cl. G06Q 10/06

(52) U.S. Cl. CPC G06Q 10/06316
USPC 705/7.26

(57) ABSTRACT

A method for online planning of a workflow for a job of processing an article in a plant in which other articles are currently being processed, may include, for each stage of the processing, assigning a machine cost value to each machine of the plant that is capable of executing that stage, the machine cost value being an exponential function of a current congestion of that machine. The method may also include constructing a plurality of workflow routes, each workflow route including a series of selected machines such that each selected machine of the series is capable of executing a different stage of the processing,. The method of may further include calculating for each workflow route of the plurality of workflow routes a route cost function that is based on the machine cost functions of the selected machines of that workflow route. The method may also include selecting a workflow route from the plurality of workflow routes based on the calculated route cost functions and processing the article along the selected workflow route.

### BACKGROUND

Digital commercial print workflows begin with digital documents, (e.g. PDF files), and end with physical documents. Before the actual print, the workflow is typically entirely digital and within the print shop is predominantly automatic. Commercial printing is usually characterized by a high variety of jobs that pass through the PSP (Print Service Provider). The flow in the PSP is jumbled, setups are in many cases common, and the environment has more of an atmosphere of project work than a systematic manufacturing process. This poses considerable challenges and opportunities in improving the manufacturing processes of PSPs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. It should be noted that the figures are given as examples only and in no way limit the scope of the invention. Like components are denoted by like reference numerals.

FIG. 1 illustrates a method for online planning of a workflow of processing an article in a plant in which other articles are currently being processed, in accordance with embodiments of the present invention.)

FIG. 2 illustrates a workflow shared by a plurality of PSP products

FIG. 3 illustrates a PSP set-up, with n machines arranged in parallel, and followed by m machines arranged in series.

FIG. 4 is a schematic block diagram of a controller for online planning of a workflow of processing an article in a plant in which other articles are currently being processed, in accordance with embodiments of the present invention.

### DETAILED DESCRIPTION

Plan choosing and scheduling are typically two basic (related) steps in the manufacturing process. Typically, a plan choosing problem has as input a set of possible courses of actions for each job and a cost measure for each action. The output, or solution, to the problem is one course of action (path) that desirably optimizes the overall performance according to a predefined criterion. Scheduling proceeds the plan choosing step and may include a set of (single plan) jobs where each job may include a partially-ordered set of tasks. In addition, it may include a set of machines, where each machine is capable of carrying out a subset of the set of all tasks. A feasible solution to a scheduling problem may include mapping from tasks to machines over specified intervals of time, so that no machine has assigned to it more than one task at a time, and each task is completed before starting any other task that follows it in the specified partial order.

Scheduling and plan choosing may be closely coupled to each other. In many instances, neither scheduling nor plan choosing can be evaluated alone without considering the other component. For example, choosing similar plans for two different jobs may over-utilize the relevant machines (and produce a suboptimal solution) if the jobs are scheduled successively. Yet, it may be the best solution for these jobs (e.g., since these are the “natural” plan executions) if the jobs are scheduled at different times. Unfortunately, from a computational and combinatorial viewpoint, processing both steps concurrently may pose a problem.

According to embodiments of the present invention scheduling and plan choosing may be treated separately by assuming that there is a time difference T such that jobs, which are executed more than T units of time away from each other, cannot compete on the same PSP resources. Hence, it is proposed to assign a single plan for each job in the time window T such that maximum number of jobs can be executed concurrently.

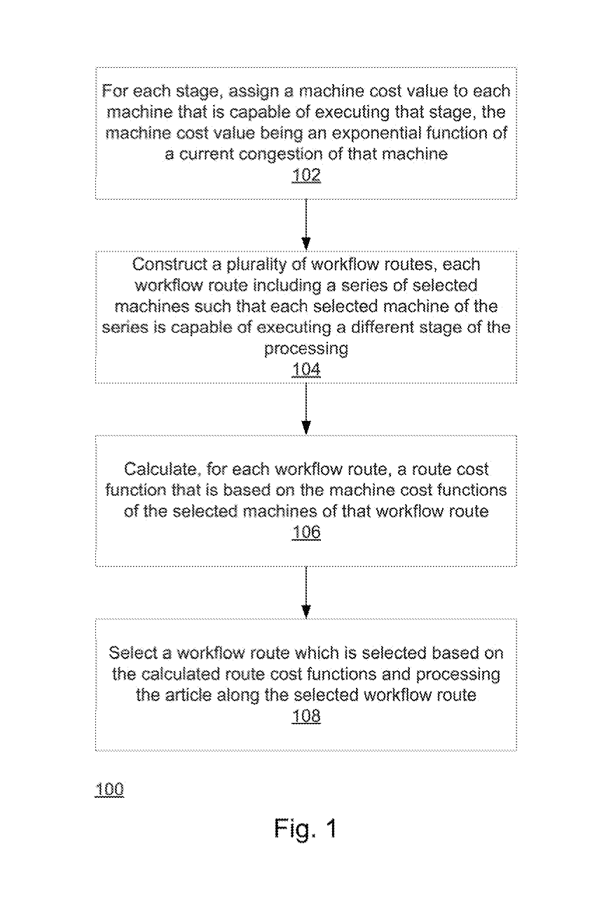

FIG. 1 illustrates a method for online planning of a workflow of processing an article in a plant in which other articles are currently being processed, in accordance with embodiments of the present invention.

In accordance with embodiments of the present invention a method 100 for online planning of a workflow of processing an article in a plant in which other articles are currently being processed is proposed. The method may include, for each stage of the processing, assigning 102 a machine cost value to each machine of the plant that is w capable of executing that stage. The machine cost value may be selected to be an exponential function of a current congestion of that machine. The method may also include constructing 104 a plurality of workflow routes, each workflow route including a series of selected machines such that each selected machine of the series is capable of executing a different stage of the processing. The method may also include calculating 106 for each workflow route of the plurality of workflow routes a route cost function that is based on the machine cost functions of the selected machines of that workflow route. The method may further include selecting 108 a workflow route from the plurality of workflow routes based on the calculated route cost functions and processing the article along the selected workflow route.

It may be assumed that in realistic settings jobs arrive one at a time and there is no a-priori knowledge regarding future job arrivals. Each job may specify a list of alternative plan executions that include the required machines and their modes of operation. Using a method for online planning of a workflow of processing an article in a plant in which other articles are concurrently being processed, according to embodiments of the present invention, balancing of the load in the PSP may be achieved. The proposed load balancing objective generalizes the well known maximum flow objective.

One may consider optimizing this objective in an online environment. More specifically, upon the arrival of a new job (with multiple possible executions), an algorithm to select a single execution path, according to embodiments of the present invention, is presented so that the overall selection may minimize the load in the PSR

Such algorithm may assign to each machine a cost that is exponential with respect to its congestion. Similar costs have been employed in the literature in the context of routing and flow control. For example, exponential costs were used in order to derive offline approximations for some multi-commodity flow problems; intuitively, the main idea behind these approximations is that the use of exponential costs in a min-cost flow computation penalizes the use of links with high congestion. Link costs that are exponential in congestion are known to have been employed in order to route demands w in an online fashion specifically, upon the arrival of a new request, these schemes are used to compute a “best” route with respect to exponential link costs and then assign the demand along the resulting route.

In accordance with embodiments of the present invention, it may established that identifying for each new job the shortest path for execution (with respect to the is exponential costs) achieves a maximum machine utilization that is at most O(log M) larger than the optimal (offline) solution, where M is the number of machines in the PSP.

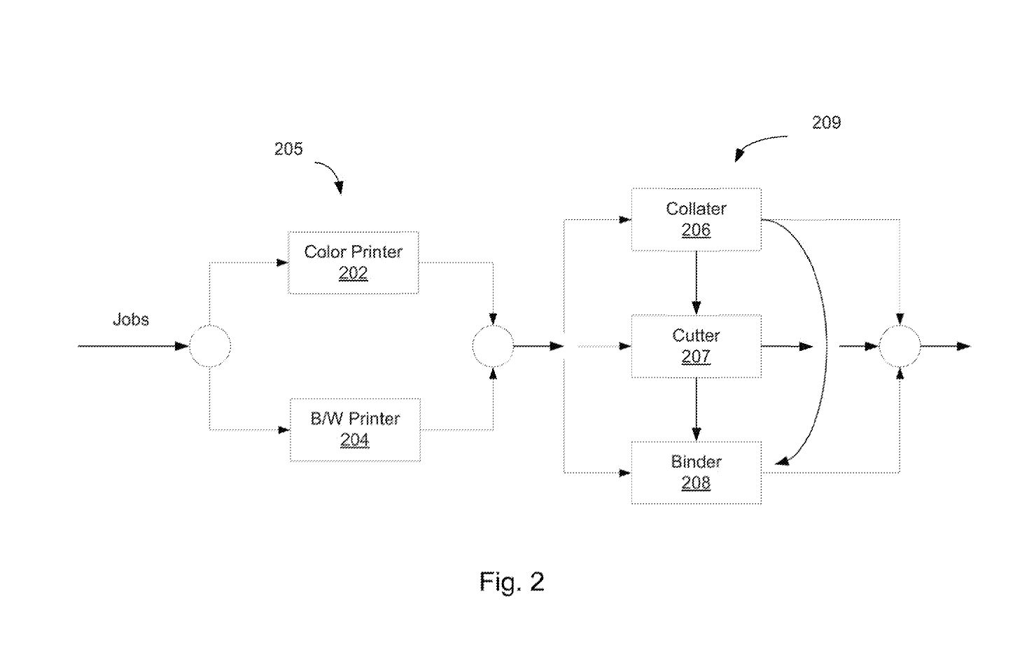

FIG. 2 illustrates a workflow shared by a plurality of PSP products. The depicted workflow is in the form of a DAG (Directed Acyclic Graph) and includes two main stages: printing 205 and finishing 209. In standard PSP workflows, printing is usually done before finishing. Similarly, the finishing machines are usually used in a predetermined order. For example, jobs enter the workflow and are first printed, either by color printer 202 or black and white (BNV) printer 204. At the finishing stage, in the example illustrated in FIG. 2, collater 206, cutter 207 and binder 208 are provided. Collating is typically performed before cutting, whereas cutting is typically done before binding. This acyclic connectivity between the finishing machines is also characterized by “bypasses” that allow forwarding jobs to machines that are more downstream. This means that a job may, for example, use the collator and then the binder while skipping over the cutter (indicated by the arrow connecting collater 206 directly with binder 208). Similarly a job may skip over the collator and use only the cutter and the binder.

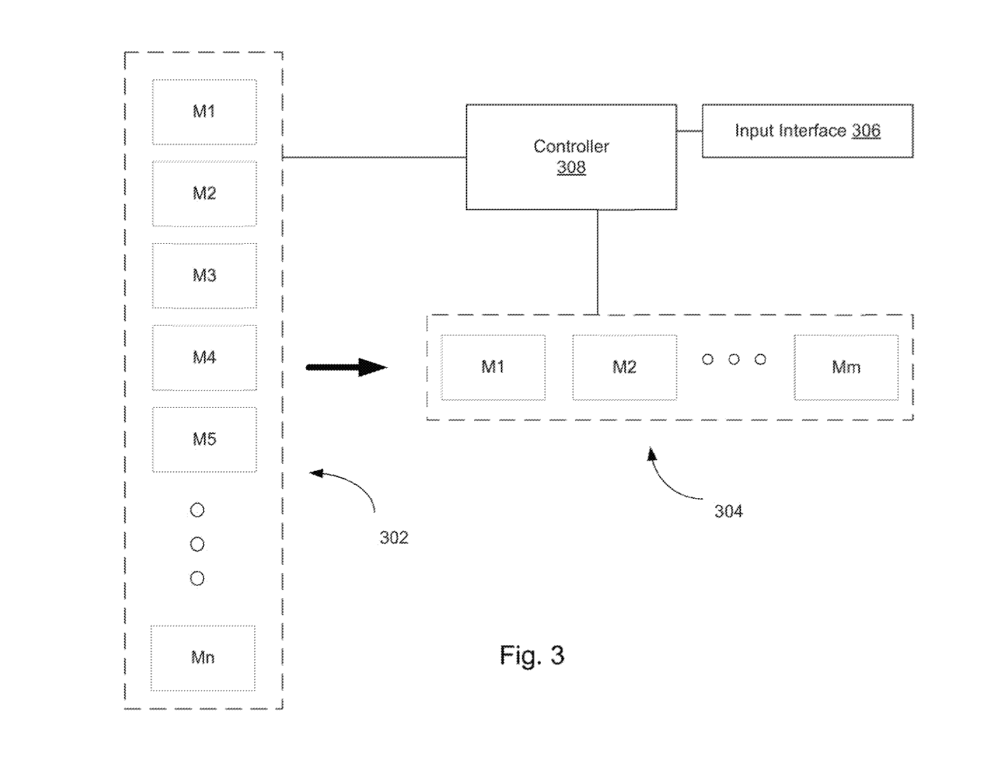

It may be possible to omit these bypasses by allowing the finishing machines to process jobs at zero time. In that case, jobs may be “passed” at zero time through the unused machines instead of bypassing them. This, together with the assumption that there may be more than two printers in parallel and more than three printers in series facilitates modeling of the production in PSP as n machines in parallel followed by m machines in series. Accordingly, FIG. 3 illustrates a PSP set-up, with n machines 302 (M1, M2, . . , Mn) arranged in parallel, and followed by m machines 304 (M1, M2 . . . Mm) in series.

Controller 308, may be included, which receives information on the currently processed jobs from the parallel machines 302 and from the machines in series 304. Additionally, controller 308 may receive information on a new job that is planned to be undergo processing through the PSP via Input interface 306. Controller 308 may also automatically issue commands to the machines (302, 304) for forwarding a new job through a selected workflow route, which was determined in accordance with embodiments of the present invention.

A job consists of a collection of one or more execution plans (also referred to as “workflow routes”). Each plan p is a sequence of machines i.e., p=(m1, m2, . . . , mn). For each machine m ∈ M and a job p there is a processing time Tm(p). Moreover, given a pair of plans p₁ p₂, one may assume that each machine MEM has a setup time that reflects the transition between plan p₁ and p₂. Plan choosing includes selecting a single plan for each job among all possible alternative plans.

Machine utilization may be defined as the ratio between the load placed over the machine (e.g. number of sheets) and the machine capacity (e.g., sheets per minute).

The competitive ratio (i.e. a measure of how the online algorithm performs with respect to an optimal offline algorithm) of an online algorithm may be defined as the supremum over all input sequences of the performance achieved by the optimal offline algorithm and the performance achieved by the given online algorithm. Accordingly, in the context of the present invention, the competitive ratio refers to the worst-case ratio between the maximal machine utilization achieved by an online algorithm and that achieved by an optimal offline algorithm.

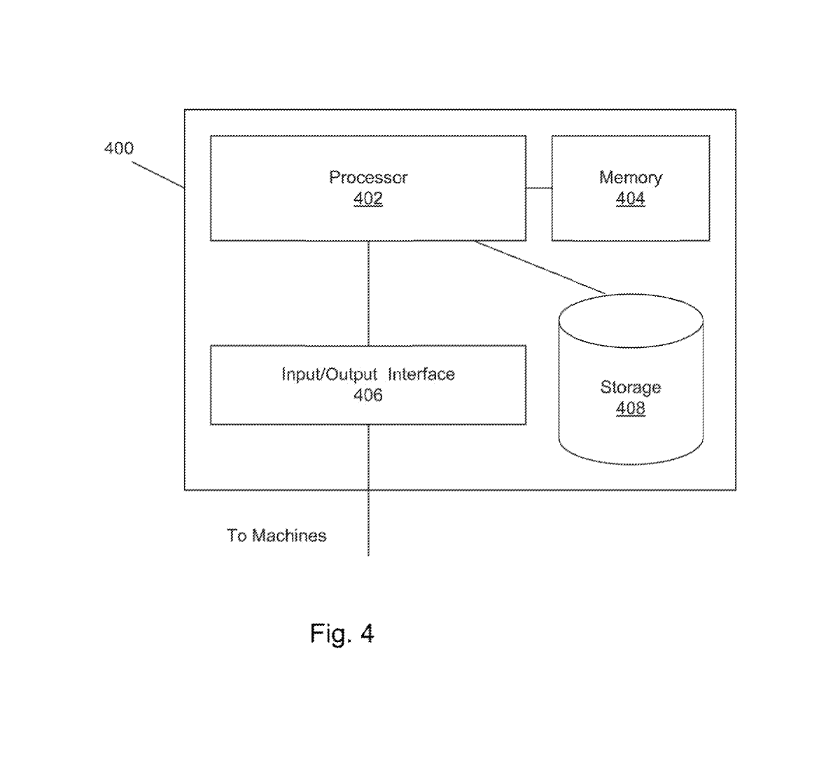

FIG. 4 is a schematic block diagram of a controller for online planning of a workflow of processing an article in a plant in which other articles are currently being processed, in accordance with embodiments of the present invention.

Controller 400 may include processor 402, for executing method steps in accordance with embodiments of the present invention. Memory 404 may be included, as well as long-term storage device 408, for storing information and executable programs that include instructions for execution by processor 402, in accordance with w embodiments of the present invention. Input/Output interface 406 may be included, for interfacing with the machines of the plant, as well as other devices, such as, for example, keyboards, pointing devices, input devices, output devices, display devices, printers etc.

Given a collection of N jobs, each with different alternative plans, it may be desired to select for each job a single plan while balancing the load in the PSP. The PSP load may be defined as the utilization of the most utilized machine. It was already mentioned that a favorable solution for the plan choosing step is one that maximizes the concurrent assignment of various jobs. Hereinafter it is shown that minimizing the maximum machine utilization may be equivalent to maximizing throughput (flow) for a single commodity case.

Theorem 1: Given a network G(V,M), where V is the set of all buffers preceding each machine of machines M, two nodes s,t, machine capacities {cₘ} and a demand γ, {fₘ} is a solution to the instance [symbol] G(V,M), {cₘ}, {s,t} [symbol] of the Maximum Flow Problem that transfers F≧γ flow units from s to

$$tiff \{ {f}_{m} \cdot \frac{γ}{F} \}$$

is a link flow that transfers γ flow units from s to t such that the network congestion factor is minimized.

Proof: It is easy to see that since {fₘ} is a vector that satisfies the capacity and flow conservation constraints, then the vector

$$\{ {f}_{m} \cdot \frac{γ}{F} \}$$

must also satisfy these constraints. In addition, since {fₑ} transfers F flow units from s to t i.e., Σ_{mε0(s)}fₑ−Σ_{mε1(s)}fₑ=F then if follows that

$${\sum }_{m ∈ O ( s )} \frac{γ}{F} {f}_{m} - {\sum }_{m ∈ t ( s )} \frac{γ}{F} {f}_{m} = \frac{γ}{F} ( {\sum }_{m ∈ O} {f}_{m} - {\sum }_{m ∈ t} {f}_{m} ) = \frac{γ}{F} \cdot F = γ flow$$

units. Thus,

$$\{ {f}_{m} \cdot \frac{γ}{F} \}$$

is a link now mat transfers γ flow units from s to t. It is left to be shown that the value

$$α {max}_{m ∈ M} \{ \frac{{f}_{m}}{{c}_{m}} \cdot \frac{γ}{F} \}$$

is the minimum of all link flows that transfer γ flow units from s to t. Since there must be a link that satisfies fₘ=cₘ it follows that

$$α = \frac{γ}{F} .$$

By way of contradiction, suppose that there exists a link flow {fₘ} that transfers γ flow units from s to t, such that

$$α {max}_{m ∈ M} \{ \frac{{f}_{m}}{{c}_{m}} \} < \frac{γ}{F} .$$

Consider the vector

$$\{ \frac{{f}_{m}}{α} \} .$$

It is evident that he network congestion factor is 1 and therefore the capacity constraints are satisfied. Since the flow conservation constraints are also satisfied, the vector

$$\{ \frac{{f}_{m}}{α} \}$$

is a link flow. It is given that Σ_{mε0(s)}fₘ−Σ_{mε1(s)}fₘ=α. Therefore,

$${\sum }_{m ∈ O ( s )} \frac{{f}_{m}}{α} - {\sum }_{m ∈ I ( s )} \frac{{f}_{m}}{α} = \frac{1}{α} \cdot ( {\sum }_{m ∈ O ( s )} {f}_{m} - {\sum }_{m ∈ I ( s )} {f}_{m} ) = \frac{γ}{α} > \frac{γ}{γ / F} = F .$$

Thus, link flow

$$\{ \frac{{f}_{m}}{α} \}$$

transfers more than F flow units from s to t.

Suppose that {fₘ} is a link flow that transfers γ flow units from s to t such that the network congestion factor is minimized, it is desired to show that

$$\{ {f}_{m} \cdot \frac{γ}{F} \}$$

is a link flow that transfers γ flow units from s to t. Since {fₘ} satisfies the flow conservation constraint it follows that

$$\{ {f}_{m} \cdot \frac{γ}{F} \}$$

also satisfies the flow conservation constraints. It will be shown hereinafter that link flow

$$\{ {f}_{m} \cdot \frac{F}{γ} \}$$

satisfies the capacity constraints. To that end, it is noted that the network congestion factor of {fₘ} is at most

$$\frac{γ}{F} .$$

Proving that will show that the maximum network congestion factor is not larger than 1 and thus the capacity constraints are satisfied.

Suppose that the link flow {fₘ} has a network congestion factor that is larger than

$$\frac{γ}{F}$$

and consider the link flow {fₘ} that was defined to be the solution to the instance [symbol] G(V,M), {cₘ}, {s, t} [symbol] of the Maximum Flow Problem that transfers F≧γ flow units form s to t. It is easy to see that the link flow

$$\{ \frac{γ}{F} \cdot {f}_{m} \}$$

transfers γ flow units from s to t. In addition, since the link flow {fₘ} is a solution to the Maximum Flow Problem, it follows that there exists one link in m ∈ M such that fₘ=cₘ. Thus, the network congestion factor of the link flow

$$\{ \frac{γ}{F} \cdot {f}_{m} \}$$

has a network congestion factor that is equal to

$$\frac{γ}{F} .$$

This contradicts the optimality of {fₘ}. It is now left to be shown that the link flow

$$\{ {f}_{m} \cdot \frac{F}{γ} \}$$

transfers F flow units from s to t. To that end, the fact that {fₘ} transfers γ flow units from s to t is employed, as follows.

$${\sum }_{m ∈ O ( s )} \frac{F}{γ} {f}_{m} - {\sum }_{m ∈ I ( s )} \frac{F}{γ} {f}_{m} = \frac{F}{γ} ( {\sum }_{m ∈ O ( s )} {f}_{m} - {\sum }_{m ∈ I ( s )} {f}_{m} ) = \frac{F}{γ} \cdot γ = F .$$

Hence Theorem 1 is established.

Now the plan choosing problem is addressed. Given a collection of M machines, o each with different alternative plans, it may be desired to select for each job a single alternative plan such that the maximum machine utilization is minimized. To that end, each machine is assigned a cost that is exponential with respect to its congestion. As mentioned similar link costs have been employed in the literature. In accordance with embodiments of the present invention, a variant of the above exponential cost functions is defined in order to establish an online strategy for plan choosing with a competitive ratio of O(log M).

Definition 1: Given are a PSP and a load Xₘ for each machine m. Let j be a new job that induced an additional load xₘ over each machine m. Then, the cost Iₘ(xₘ) of each machine m is defined as follows:

$${l}_{m} ( {X}_{m} ) = {( \frac{3}{2} )}^{\frac{{X}_{m} + {x}_{m}}{{c}_{m}}} - {( \frac{3}{2} )}^{\frac{{X}_{m}}{{c}_{m}} }$$

Given a PSP (i.e. a set of machines M) and maximum machine utilization α, upon the arrival of new job j with a predetermined list of plans P, the following exemplary procedure may be used to compute the cheapest (least costly) plan p ∈ P with respect to the exponential link costs (lₘ(xₘ(k))}.

Procedure Planning (j, M, {cₘ}, {Xₘ(k−1)}, xₘ(k), α)

Parameters:

M—set of machines (PSP)

j—a new job

{cₘ}—machine capacities

{Xₘ(k−1)}—the utilization induced by all previous k−1 jobs

{xₘ(k)}—the machine loads induced by job j.
α—the restriction on maximum machine utilization

1. Select a plan p with the minimal total weight with respect to all plans that constitute job j.

2. If there exists m ∈ p such that

$$\frac{{X}_{m} ( k - 1 ) + {x}_{m} ( k )}{{c}_{m}} > α \cdot {log}_{\frac{3}{2}} ( 2 M )$$

Return Fail

Else

Return path p

Definition 2: Given an instance of the planning problem, denote by αₖ^{*s} the maximum machine utilization of the optimal offline solution that considers the first k requests (jobs). i.e.,

$${α}_{k}^{*} = {max}_{m ∈ M} \{ \frac{{X}_{m}^{*} ( k )}{{c}_{m}} \} .$$

Theorem 2: Given an instance of the planning problem, if αₖ^{*}≦α, online planning of a workflow for processing an article in a plant (hereinafter referred to, for brevity, as Procedure Planning) never fails. Hence, the returned path induces a maximum machine utilization of α-log _{3/2} (2M) at most.

Proof: Consider the following potential function

$$Φ ( k ) = {\sum }_{m ∈ M} {( \frac{3}{2} )}^{\frac{{X}_{m} ( k )}{α {c}_{m}}} ( 2 - \frac{{α}_{k}^{*}}{α} ) .$$

First, it would be shown that Φ(k)−Φ(k−1)≦0.

$$\begin{matrix}Φ ( k ) - Φ ( k - 1 ) = {\sum }_{m ∈ M} {( \frac{3}{2} )}^{\frac{{X}_{m} ( k )}{α {c}_{m}}} ( 2 - \frac{{α}_{k}^{*}}{α} ) - {\sum }_{m ∈ M} {( \frac{3}{2} )}^{\frac{{X}_{m} ( k - 1 )}{α {c}_{m}}} ( 2 - \frac{{α}_{k - 1}^{*}}{α} ) = \\ = {\sum }_{m ∈ M} {( \frac{3}{2} )}^{\frac{{X}_{m} ( k )}{α {c}_{m}}} \cdot [ 2 - \frac{1}{α} ( \frac{{X}_{m}^{*} ( k - 1 ) + {x}_{m}^{*} ( k )}{{c}_{m}} ) ] - \\ {\sum }_{m ∈ M} {( \frac{3}{2} )}^{\frac{{X}_{m} ( k - 1 )}{α {c}_{m}}} \cdot ( 2 - \frac{{α}_{k - 1}^{*}}{α} ) = \\ = {\sum }_{m ∈ M} {( \frac{3}{2} )}^{\frac{{X}_{m} ( k )}{α {c}_{m}}} \cdot [ 2 - \frac{1}{α} ( {α}_{k - 1}^{*} + \frac{{x}_{m}^{*} ( k )}{{c}_{m}} ) ] - \\ {\sum }_{m ∈ M} {( \frac{3}{2} )}^{\frac{{X}_{m} ( k - 1 )}{α {c}_{m}}} \cdot ( 2 - \frac{{α}_{k - 1}^{*}}{α} ) = \\ = {\sum }_{m ∈ M} {( \frac{3}{2} )}^{\frac{{X}_{m} ( k )}{α {c}_{m}}} \cdot [ 2 - \frac{{α}_{k - 1}^{*}}{α} - \frac{{x}_{m}^{*} ( k )}{α {c}_{m}} ] - {\sum }_{m ∈ M} {( \frac{3}{2} )}^{\frac{{X}_{m} ( k - 1 )}{α {c}_{m}}} \cdot \\ ( 2 - \frac{{α}_{k - 1}^{*}}{α} ) = \\ = ( 2 - \frac{{α}_{k - 1}^{*}}{α} ) \cdot {\sum }_{m ∈ M} ( {( \frac{3}{2} )}^{\frac{{X}_{m} ( k )}{α {c}_{m}}} - {( \frac{3}{2} )}^{\frac{{X}_{m} ( k - 1 )}{α {c}_{m}}} ) - \\ {\sum }_{m ∈ M} {\frac{3}{2} }^{\frac{{X}_{m} ( k )}{α {c}_{m}}} \cdot \frac{{x}_{m}^{*} ( k )}{α {c}_{m}} \leq \\ \leq 2 \cdot {\sum }_{m ∈ M} ( {( \frac{3}{2} )}^{\frac{{X}_{m} ( k )}{α {c}_{m}}} - {( \frac{3}{2} )}^{\frac{{X}_{m} ( k - 1 )}{α {c}_{m }}} ) - {\sum }_{m ∈ M} {( \frac{3}{2} )}^{\frac{{X}_{m} ( k - 1 )}{α {c}_{m }}} \cdot \\ \frac{{x}_{m}^{*} ( k )}{α {c}_{m}} = \\ = 2 \cdot {\sum }_{m ∈ M} ( {( \frac{3}{2} )}^{\frac{{X}_{m} ( k - 1 ) + {x}_{m} ( k )}{α {c}_{m}}} - {( \frac{3}{2} )}^{\frac{{X}_{m} ( k - 1 )}{α {c}_{m}}} ) - \\ {\sum }_{m ∈ M} {( \frac{3}{2} )}^{\frac{{X}_{m} ( k - 1 )}{α {c}_{m}}} \cdot \frac{{x}_{m}^{*} ( k )}{α {c}_{m}}\end{matrix}$$

Since a plan p is identified that minimizes the total cost

$${\sum }_{m ∈ M} {l}_{m} ( \cdot )$$

with respect to all possible plans in P it follows that

$${\sum }_{m ∈ M} {l}_{m} ( {x}_{m} ( k ) ) \leq {\sum }_{m ∈ M} {l}_{m} ( {x}_{m}^{*} ( k ) ) .$$

Thus, by definition,

$${\sum }_{m ∈ M} ( {( \frac{3}{2} )}^{\frac{{X}_{m} ( k - 1 ) + {x}_{m} ( k )}{α {c}_{m}}} - {( \frac{3}{2} )}^{\frac{{X}_{m} ( k - 1 )}{α {c}_{m}}} ) \leq {\sum }_{m ∈ M} ( {( \frac{3}{2} )}^{\frac{{X}_{m} ( k - 1 ) + {x}_{m}^{*} ( k )}{α {c}_{m}}} - {( \frac{3}{2} )}^{\frac{{X}_{m} ( k - 1 )}{α {c}_{m}}} ) .$$

Therefore, this inequality may be used as follows:

$$Φ ( k ) - Φ ( k - 1 ) \leq 2 \cdot {\sum }_{m ∈ M} ( {( \frac{3}{2} )}^{\frac{{X}_{m} ( k - 1 ) + {x}_{m} ( k )}{α {c}_{m}}} - {( \frac{3}{2} )}^{\frac{{X}_{m} ( k - 1 )}{α {c}_{m}}} ) - {\sum }_{m ∈ M} {( \frac{3}{2} )}^{\frac{{X}_{m} ( k - 1 )}{α {c}_{m}}} \cdot \frac{{x}_{m}^{*} ( k )}{α {c}_{m}} \leq \leq 2 \cdot {\sum }_{m ∈ M} {( \frac{3}{2} )}^{\frac{{X}_{m} ( k - 1 ) + {x}_{m}^{*} ( k )}{α {c}_{m}}} - {( \frac{3}{2} )}^{\frac{{X}_{m} ( k - 1 )}{α {c}_{m}}} ) - {\sum }_{m ∈ M} {( \frac{3}{2} )}^{\frac{{X}_{m} ( k - 1 )}{α {c}_{m}}} \cdot \frac{{x}_{m}^{*} ( k )}{α {c}_{m}} == 2 \cdot {\sum }_{m ∈ M} {( \frac{3}{2} )}^{\frac{{X}_{m} ( k - 1 )}{α {c}_{m }}} \cdot ( {( \frac{3}{2} )}^{\frac{{x}_{m}^{*} ( k )}{α {c}_{m}}} - 1 - \frac{{x}_{m}^{*} ( k )}{2 α {c}_{m}} ) .$$

In order to show that

$$2 \cdot {\sum }_{m ∈ M} {( \frac{3}{2} )}^{\frac{{X}_{m} ( k - 1 )}{α {c}_{m}}} \cdot ( {( \frac{3}{2} )}^{\frac{{x}_{m}^{*} ( k )}{α {c}_{m}}} - 1 - \frac{{x}_{m}^{*} ( k )}{2 α {c}_{m}} ) \leq 0$$

it is sufficient to prove that

$${( \frac{3}{2} )}^{\frac{{x}_{m}^{*} ( k )}{α {c}_{m}}} - 1 - \frac{{x}_{m}^{*} ( k )}{2 α {c}_{m}} \leq 0 ,$$

for each m ∈ M. Note that since it is given that αₖ^{*s}≦α, it follows that

$$\frac{{x}_{m}^{*} ( k )}{{c}_{m}} \leq \frac{{X}_{m}^{*} ( k - 1 ) + {x}_{m}^{*} ( k )}{{c}_{m}} = \frac{{x}_{m}^{*} ( k )}{{c}_{m}} \leq {α}_{k}^{*} \leq α$$

for each in m ∈ M. Therefore, it holds that

$$\frac{{x}_{m}^{*} ( k )}{α {c}_{m}} ∈ [ 0 , 1 ]$$

for each m ∈ M. Thus all that needs to be proven is that

$${( \frac{3}{2} )}^{x} - 1 - \frac{x}{2} \leq 0$$

for every A in the range [0,1]. To that end it is now shown that

$$h ( x ) = {( \frac{3}{2} )}^{x} - 1 - \frac{x}{2} \leq 1$$

for each x ∈ [0,1]. First, note that on one hand h(0)=h(1)=1. On the other hand, it is easy to verify that

$${x}_{m} = \frac{ln ( ln 9 - ln 4 )}{ln 2 - ln 3} \approx 0.516$$

is the only xₘ∈ [0,1] such that

$$\frac{\partial h ( {x}_{m} )}{\partial x} = 0.$$

Hence, since h(xₘ)≈0.974<1, it holds that h(x)≦1 for each x∈ [0,1]. Thus it was established that Φ(k)−Φ(k−1)≦0. This relation is used to prove Theorem 2, i.e., show that if aₖ^{*s}≦α, then Procedure Planning never fails.

Finally, as it is given that αₖ^{*2}≦α, it follows that

$$\begin{matrix}Φ ( k ) = {\sum }_{m ∈ M}^{ } {( \frac{3}{2} )}^{\frac{{X}_{m} k}{α {c}_{m}}} ( 2 - \frac{{α}_{k}^{*}}{α} ) \geq {\sum }_{m ∈ M}^{ } {( \frac{3}{2} )}^{\frac{{X}_{m} k}{α {c}_{m}}} ( 2 - 1 ) \\ = {\sum }_{m ∈ M}^{ } {( \frac{3}{2} )}^{\frac{{X}_{m} k}{α {c}_{m}}} \geq {\sum }_{m ∈ M}^{ } {( \frac{3}{2} )}^{{\begin{matrix}max \\ m ∈ M\end{matrix}}^{\{ \frac{{X}_{m} ( k )}{α {c}_{m}} \}}}\end{matrix} \qquad ( 1 )$$

Therefore, since Φ(k)≦Φ(0), and since initially Φ(0)=2·M , it follows from (1) that

$${\sum }_{m ∈ M}^{ } {( \frac{3}{2} )}^{{\begin{matrix}max \\ m ∈ M\end{matrix}}^{\{ \frac{{X}_{m} ( k )}{α {c}_{m}} \}}} \leq 2 \cdot M .$$

### Therefore,

$${{log}_{\frac{3}{2}} ( \frac{3}{2} )}^{{\begin{matrix}max \\ m ∈ M\end{matrix}}^{\{ \frac{{X}_{m} ( k )}{α {c}_{m}} \}}} \leq {log}_{\frac{3}{2}} ( 2 \cdot M ) ⇒ {max}_{m ∈ M} \{ \frac{{s}_{m} ( k )}{α {c}_{m}} \} \leq {log}_{\frac{3}{2}} ( 2 \cdot M ) ⇒ {max}_{m ∈ M} \{ \frac{{X}_{m} ( k )}{{c}_{m}} \} \leq α \cdot {log}_{\frac{3}{2}} ( 2 \cdot M ) .$$

Hence, by construction, Procedure Planning does not fail, thus establishing Theorem 2,

Since

$$α \cdot {log}_{\frac{3}{2}} ( 2 \cdot M ) = 0 ( α \cdot log M ) ,$$

it follows that, given an instance of the plan choosing problem and a maximum machine utilization α such that αₖ^{*}≦α, Procedure Planning may be employed in order to output a plan with a maximum machine utilization that is larger than α factor of 0(log M). In particular, if one attempts to anticipate the optimal utilization αₖ^{*s}, then the procedure may be employed in order to obtain a solution with competitive ratio of 0(log M). This latter anticipation may be computed as follows:

Let αₘₐₓ be an upper bound for optimal maximum machine utilization. This may be estimated by executing concurrently all plans of all jobs that have arrived thus “20 far from selecting a single plan for each job. Then, the optimal maximum machine utilization αₖ^{*s} must be in the range αₖ^{*s}∈[0,αₘₐₓ]. Therefore, by selecting the smallest value for α in [0,αₘₐₓ] for which Procedure Planning succeeds, it is possible (according to Theorem 2) find a maximum machine utilization that deviates within a factor of 0(log M) from the optimal solution. This process may be accelerated by invoking a binary search over the range [0,αₘₐₓ]. Assuming that the number of plans per job is small (Le. constant) it is evident that the overall complexity is 0(log αₘₐₓ).

Corollary 1: Applying Procedure Planning, according to embodiments of the present invention, for each new job provides, in polynomial time, a solution with a competitive ratio 0(log M).

Aspects of the invention may be embodied in the form of a system, a method or a computer program product. Similarly, aspects of the invention may be embodied as hardware, software or a combination of both. Aspects of the invention may be embodied as a computer program product saved on one or more non-transitory computer readable medium (or mediums) in the form of computer readable program code embodied thereon. Such non-transitory computer readable medium may include instructions that when executed cause a processor to execute method steps in accordance with embodiments of the present invention. In some embodiments of the present invention the instructions stores on the computer readable medium may be in the form of an installed application and in the form of an installation package.

For example, the computer readable medium may be a non-transitory computer readable storage medium. A non-transitory computer readable storage medium may be, for example, an electronic, optical, magnetic, electromagnetic infrared, or semiconductor system, apparatus, or device, or any combination thereof.

Computer program code may be written in any suitable programming language. The program code may execute on a single computer, or on a plurality of computers.

Aspects of the invention are described hereinabove with reference to flowcharts and/or block diagrams depicting methods, systems and computer program products according to embodiments of the invention,

What is claimed is:

1. A method for online planning of a workflow for a job of processing an article in a plant in which other articles are currently being processed, the method comprising:
for each stage of the processing, assigning a machine cost value to each machine of the plant that is capable of executing that stage the machine cost value being an exponential function of a current congestion of that machine;
constructing a plurality of workflow routes, each workflow route including a series of selected machines such that each selected machine of the series is capable of executing a different stage of the processing,
calculating for each workflow route of said plurality of workflow routes a route cost function that is based on the machine cost functions of the selected machines of that workflow route; and
selecting a workflow route from said plurality of workflow routes based on the calculated route cost functions and processing the article along the selected workflow route.

2. The method of claim 1, wherein the machine cost value of each of the machines is given by
$${l}_{m} ( {X}_{m} ) = {( \frac{3}{2} )}^{\frac{{X}_{m} + {x}_{m}}{{c}_{m}}} - {( \frac{3}{2} )}^{\frac{{X}_{m}}{{c}_{m}}} ,$$
where Xₘ is a current load for each machine m and xₘ is an additional load as a result of introducing the article, and cₘ is a capacity of each of the machine.

3. The method of claim 1, wherein the step of selecting the workflow route comprises selecting a route with the minimal total weight with respect to all said plurality of workflow routes.

4. The method of claim 3, wherein the step of selecting the workflow route with the minimal total weight comprises determining whether there exists m ∈ p such that
$$\frac{{X}_{m} ( k - 1 ) + {x}_{m} ( k )}{{c}_{m}} > α \cdot {log}_{\frac{3}{2}} ( 2 M ) ,$$
where m is a machine capable of executing a stage, M is the number of the machines, cₘ is a machine capacity for each machine, Xₘ(k−1) is a utilization induced by processing previous articles, xₘ(k) is a machine loads induced by processing the article, and a is a restriction on maximum machine utilization.

5. The method of claim 1, wherein the plant is a Print Service Provider (PSP).

6. The method of claim 1, wherein the step of selecting the workflow route performed automatically.

7. The method of claim 1, wherein the step of selecting the workflow route comprises selecting the least costly workflow route.

8. The method of claim 1, wherein the step of processing the article along the selected workflow route comprises automatically issuing commands to the selected machines of the selected workflow route.

9. A non-transitory computer readable medium having stored thereon instructions for online planning of a workflow for a job of processing an article in a plant in which other articles are currently being processed, which when executed by a processor cause the processor to perform the method of:
for each stage of the processing, assigning a machine cost value to each machine of the plant that is capable of executing that stage the machine cost value being an exponential function of a current congestion of that machine;
constructing a plurality of workflow routes each workflow route including a series of selected machines such that each selected machine of the series is capable of executing a different stage of the processing,
calculating for each workflow route of said plurality of workflow routes a route cost function that is based on the machine cost functions of the selected machines of that workflow route; and
selecting a workflow route from said plurality of workflow routes based on the calculated route cost functions and processing the article along the selected workflow route.

10. The non-transitory computer readable medium of claim 9, wherein the machine cost value of each of the machines is given by
$${l}_{m} ( {X}_{m} ) = {( \frac{3}{2} )}^{\frac{{X}_{m} + {x}_{m}}{{c}_{m}}} - {( \frac{3}{2} )}^{\frac{{X}_{m}}{{c}_{m}}} ,$$
where Xₘ is a current load for each machine m and xₘis an additional load as a result of introducing the article, and cₘ is a capacity of each of the machine.

11. The non-transitory computer readable medium of claim 9, wherein the step of selecting the workflow route comprises selecting a route with the minimal total weight with respect to all said plurality of workflow routes.

12. The non-transitory computer readable medium of claim 11, wherein the step of selecting the workflow route with the minimal total weight comprises determining whether there exists m ∈ p such that
$$\frac{{X}_{m} ( k - 1 ) + {x}_{m} ( k )}{{c}_{m}} > α \cdot {log}_{\frac{3}{2}} ( 2 M ) ,$$
where m is a machine capable of executing a stage, M is the number of the machines, cₘ is a machine capacity for each machine, Xₘ(k−1) is a utilization induced by processing previous articles, Xₘ(k) is a machine loads induced by processing the article, and α is a restriction on maximum machine utilization,

13. The non-transitory computer readable medium of claim 9, wherein the step of selecting the workflow route comprises selecting the least costly workflow route.

14. A system for online planning of a workflow for a job of processing an article in a plant in which other articles are currently being processed, the system comprising a processor configured to:
for each stage of the processing, assign a machine cost value to each machine of the plant that is capable of executing that stage, the machine cost value being an exponential function of a current congestion of that machine;
construct a plurality of workflow routes, each workflow route including a series of selected machines such that each selected machine of the series is capable of executing a different stage of the processing,
calculate for each workflow route of said plurality of workflow routes a route cost function that is based on the machine cost functions of the selected machines of that workflow route: and
select a workflow route from said plurality of workflow routes based on the calculated route cost functions and process the article along the selected workflow route.

15. The system of claim 14, wherein the machine cost value f each of the machines is given by
$${l}_{m} ( {X}_{m} ) = {( \frac{3}{2} )}^{\frac{{X}_{m} + {x}_{m}}{{c}_{m}}} - {( \frac{3}{2} )}^{\frac{{X}_{m}}{{c}_{m}}} ,$$
where Xₘ is a current load for each machine m and xₘ is an additional load as a result of introducing the article, and cₘ is a capacity of each of the machine.

16. The system of claim 14, wherein the processor is configured to select the workflow route by selecting a route with the minimal total weight with respect to all said plurality of workflow routes.

17. The system of claim 16, wherein the processor is configured to select the workflow route with the minimal total weight by determining whether there exists m ∈ p such that
$$\frac{{X}_{m} ( k - 1 ) + {x}_{m} ( k )}{{c}_{m}} > α \cdot {log}_{\frac{3}{2}} ( 2 M ) ,$$
where m is a machine capable of executing a stage, M is the number of the machines, cₘ is a machine capacity for each machine, Xₘ(k−1) is a utilization induced by processing previous articles, xₘ(k) is a machine loads induced by processing the article, and α is a restriction on maximum machine utilization.

18. The system of claim 14, wherein the plant is a Print Service Provider (PSP).

19. The system of claim 14, wherein the processor is configured to select the workflow route by selecting the least costly workflow route.

20. The system of claim 14, wherein the processor is configured when performing the step of processing the article along the selected workflow route to automatically issue commands to the selected machines of the selected workflow route.
